(19) United States
(12) Patent Application Publication
(10) Pub. No.: US 2025/0083077 A1
(43) Pub. Date: Mar. 13, 2025

(54) WATER FILTER AND METHOD FOR OPERATING A WATER FILTER

(71) Applicant: Aquis Systems AG, Rebstein (CH)

(72) Inventors: Kai Huck, Walzenhausen (CH); Ingolf Gröning, Bad Mergentheim (DE)

(73) Assignee: Aquis Systems AG, Rebstein (CH)

(21) Appl. No.: 18/825,743

(22) Filed: Sep. 5, 2024

(30) Foreign Application Priority Data
Sep. 7, 2023 (DE) 10 2023 124 150.8

(51) Int. Cl. B01D 35/143; B01D 35/12; B01D 35/30; C02F 1/00; C02F 1/42

(52) U.S. Cl. CPC B01D 35/143; B01D 35/12; B01D 35/306; C02F 1/003; C02F 1/008; C02F 1/42; B01D 2201/56; C02F 2209/445

(57) ABSTRACT

Water filter for filtering water, in particular for filtering water in a household and/or in particular for filtering water at a maximum flow rate of 20 l/min, having a filter holder having a position sensor and a container that is couplable to the filter holder. The container contains a passage element, which is movable relative to a container opening of the container and has a passage opening, a feed for feeding water to the passage element, an adjusting device for adjustably positioning the passage element having the passage opening relative to the container having the container opening, and an emitter. The emitter is configured to interact with the position sensor, so that the position sensor is configured to output a position signal that is indicative of a position of the passage element having the passage opening.

### TECHNICAL FIELD

The invention relates to a water filter and a method for operating a water filter. In particular, the invention relates to a water filter having an emitter and a sensor for detecting a position of a passage element, in particular for determining a blend level of the filtered water.

### RELATED ART

The prior art discloses water filter systems that filter tap water by passing it through various other materials and/or that remove calcium from the water by means of other measures, for example by means of chemical reactions.

The prior art discloses water filters that have a unique identifier (e.g. RFID) that allows the water filter to be uniquely identified by the equipment. It is also known that these unique identifiers can have additional information written to them by the equipment, for example utilization level or service life.

The prior art discloses that these water filter systems have an option to set a defined blend level. Blend level is understood to mean what proportion of for example unfiltered untreated water is added back to the filtered water so that the water hardness and the pH value of the water is suitable for directly consumed drinking water.

In known water filters, the water in the water filter is often routed to ion exchange resin over the entire distance, with the result that, depending on the level of hardness of the water at the inlet, excessive demineralization can occur, this being compensated for again by adding untreated water. This blending process generally takes place in the filter holder, for example by adjusting an adjusting element from the inside or from the outside.

One particular disadvantage of the solution is if the blending process results in the filtered water having untreated water added back to it that can contain particles, heavy metals or microplastics, meaning that the filtered water also contains these pollutants again.

Another disadvantage is that the service life of the water filter is not dependent on the mostly purely mechanical setting of the blend level in the filter holder. Thus, in particular in the case of softer water, for which a high blend level needs to be chosen, the ion exchange resin is traversed by only a relatively small volume flow, meaning that a lot of ion exchange resin is still unused during the cycle of filter usage. As a result, many resources are wasted.

### SUMMARY OF THE INVENTION

The object of the invention is to solve the problems from the prior art, at least in part. In particular, the object of the invention is to specify a water filter and a method for operating a water filter that advantageously permit the water filter to be operated on the basis of an adjustable blend level.

The object is achieved by a water filter and a filter system and a method for operating a water filter as disclosed herein and according to the coordinate claims. Advantageous developments and embodiments result from the subclaims and from this description.

A first aspect of the invention relates to a water filter for filtering water, in particular for filtering water in a household and/or in particular for filtering water at a maximum flow rate of 20 l/min, having a filter holder having a position sensor and a container that is couplable to the filter holder. The container contains a passage element, which is movable relative to a container opening of the container and has a passage opening, a feed for feeding water to the passage element, an adjusting device for adjustably positioning the passage element having the passage opening relative to the container having the container opening, and an emitter. The emitter is configured to interact with the position sensor, so that the position sensor is configured to output a position signal that is indicative of a position of the passage element having the passage opening.

Another aspect of the invention relates to a method for operating a water filter according to one of the embodiments and/or aspects described herein. The method involves adjusting a position of the passage element having the passage opening relative to the container having the container opening in order to accommodate the water filter, and determining the position of the passage element using the position sensor.

According to one aspect, a water filter is described. The water filter may be a development of the water filter described in the application with the file reference 10 2023 118 228.5, filed at the German Patent and Trademark Office on 07.10.2023. The document is referred to in this respect and the content thereof is hereby incorporated into this application. A material of the water filter, in particular of the container and/or of the filter holder, is not essential to the present invention.

In embodiments, omitting blending with untreated water given adjustable demineralization advantageously allows complete filtering of the water, and therefore the absence of sediments, heavy metals and/or microplastics, to be ensured.

In embodiments, detecting the position of the passage element advantageously allows the set position of the passage element to be detected. Detection can advantageously take place contactlessly and/or automatically. In particular, detecting the position allows the actual depletion of one or more filter elements of the water filter to be determined. The remaining service life of the water filter and/or of the filter elements of the water filter may advantageously be more precisely determinable.

In embodiments, the user's easily setting the hardness level using an adjusting wheel, which is also easily accessible, advantageously allows the capacity of the filter to be fully utilized. In particular, resources can be saved.

In embodiments, values, in particular container values and/or container depletion state values, can advantageously be written to a transponder of the container. This allows the capacity of the filter, in particular a remaining capacity of the filter, to be used even when the filter is changed to a different piece of equipment or when a different filter is temporarily used.

### BRIEF DESCRIPTION OF THE DRAWINGS

The present invention is explained in more detail below with reference to the accompanying drawings, in the figures of which:

FIG. 1 shows a schematic view of a water filter according to a typical embodiment,

FIG. 2 shows a method for operating a water filter according to a typical embodiment, and

FIG. 3 shows a container for a water filter.

### DETAILED DESCRIPTION

Typical embodiments of the invention are described below with reference to the figures, the invention not being limited to the exemplary embodiments, but rather the scope of the invention being determined by the claims. In the description of the embodiment, identical reference numerals are sometimes used for identical or similar parts in different figures and for different embodiments, in order to make the description clearer. However, this does not mean that corresponding parts of the invention are limited to the variants shown in the embodiments. Where the term “or” is used herein without further details, this term is understood to mean “and/or”, unless the context occasions something else.

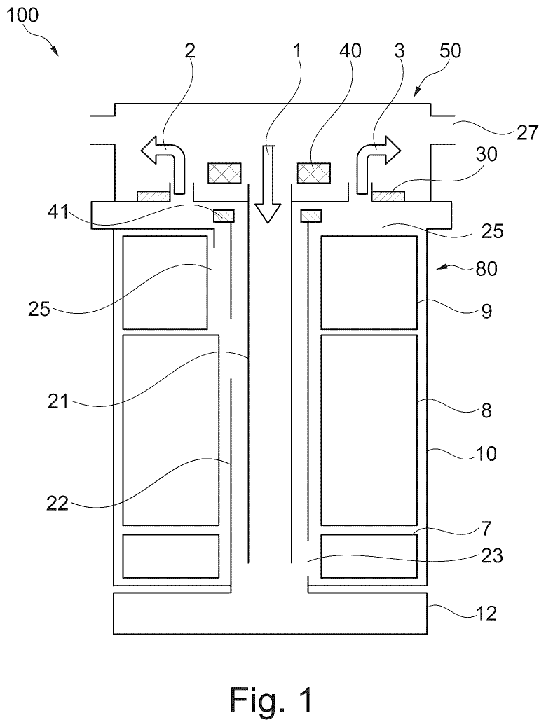

FIG. 1 shows a schematic view of an exemplary embodiment of a water filter 100. The water filter comprises an inlet 1 for unfiltered water, which finds its way from the inlet to a feed 21. The feed is cylindrical and extends centrally along an opening in a container 80 in which different filter elements, more specifically a particle filter 7, a carboblock 8 and an exchange resin 9, are arranged.

Furthermore, a passage element 22 having passage openings extends coaxially around the feed 21. The container 80 has an opening centrally along a central axis. Typical water filters comprise a container having a continuous opening that is formed by an internal wall of the container, the container openings being provided in the internal wall. Typical internal walls are cylindrical. Typical covers of embodiments have a central opening. Typical containers of embodiments are cylindrical, conical or pot-shaped.

Typical feeds have a feed pipe that is arranged so as to be coaxial with the container or with the passage element. Typical passage elements are cylindrical, the passage openings being provided in the circumferential surface. By positioning seals, for instance O-rings or mechanical seals (not shown), between the feed 21 and the passage element 22, the flow of water from the inlet 1 through the respective filter elements to the respective outlets 2, 3 may be defined.

Typical water filters are particularly suitable for filtering water in a household or in particular for filtering water at a maximum flow rate of 50 l/min or 20 l/min maximum. A container is typically intended for receiving filter elements, and a feed for feeding water to a passage element.

The passage element 22 typically has a plurality of passage openings, the container having a plurality of container openings provided in it. Suitable positioning of the passage openings relative to the container openings allows different paths to be set for the water through the filter, or relative flow rates through different filter elements to be controlled. It may also be possible to set paths for which the water flowing through the filter does not flow through all of the filter elements or, in some embodiments, does not flow through any filter elements. To adjust the passage element, typical embodiments have an adjusting device for adjustably positioning the passage element relative to the container. This setting can optionally also be achieved using a shiftable perforated plate between the different filter elements, which is twisted or shifted against a stationary perforated plate.

In the embodiment in FIG. 1, a lower end of the passage element 22 has provision for an adjusting wheel 12 that can be used to set the angular orientation of the cylindrical passage element 22 relative to the container 80. In particular, the adjusting device may be configured to adjustably position the passage element 22 relative to the container opening by means of rotation about an axis, for example a concentric and/or central axis of the container. This adjusts the orientation of passage openings 23 of the passage element 22 relative to container openings 25 of the container. A partial overlap of the openings allows the cross section to be set for the water flowing through.

In typical embodiments, the adjusting wheel 12 is arranged below the container. “Top” and “bottom” are intended to be understood merely as labels for distinguishing the position on the water filter; the water filter can also be used recumbently or upside down.

Like typical embodiments, the water filter 100 in FIG. 1 has a cover that closes the container 80 in particular at an upper end, that is to say opposite the adjusting wheel 12.

As in the embodiment in FIG. 1, typical embodiments have the cover connected to the container 80 in such a way that nondestructive removal of the cover from the container 80 is possible only using a tool. The tool is typically a special tool. By way of example, special tools are distinguished in that they can be used to release latching lugs or more generally attachment means that are not easily releasable, or not releasable as intended, using typical standardized tools. Typical connections may be, as in FIG. 1, a connecting edge of the container 10, which is shown only very schematically, with a bayonet closure having a latching lug, for example.

In variant embodiments, the cover of the filter and the container also have a security element between them that breaks when the connection between the cover and the container is opened, meaning that the element provides a secure form-fit connection that, after being opened, for example by unauthorized parties, can ensure that a fresh form-fit connection cannot be produced again. In typical embodiments, fresh production of a form-fit connection is then possible only by means of replacement.

The cover typically has a first outlet and a second outlet provided in it.

The cover of the embodiment in FIG. 1 has a first outlet 2 and a second outlet 3. The outlets 2 and 3 are used to discharge water from respective spaces situated upstream of the outlets 2 and 3.

With the setting shown for the adjusting wheel 12, two paths for the water that is to be filtered run through the water filter 100 in FIG. 1: by way of example, a first path runs through all of the filter elements, in particular the particle filter 7, the carboblock 8 and the exchange resin 9. A second path runs only through some of the filter elements, for example, in particular the particle filter 7 and the carboblock 8, but not the exchange resin 9. Both paths begin at the inlet 1, run through the feed 21 and on through passage opening(s) 23 of the passage element 22, through container openings 25 and the container 80. The first path ends at the first outlet 3, and the second path at the second outlet 2. Depending on the setting of the adjusting wheel 12, the respective proportions of water that flow through particular filter elements can be set.

In typical embodiments, the first outlet and the second outlet can each be assigned at least partially different paths for water through the container and filter elements arranged therein. In particular, the paths are adjustable by positioning the passage element, in particular by means of the adjusting element or adjusting wheel.

In variant embodiments, there are two outlets for one inlet, the water filter being configured in such a way that a first outlet always has water available that is filtered only by some of the filter elements or only by certain, but not all, types of filter elements, for example only the particle filter and the carboblock. In typical embodiments of water filters, a second outlet has water available that is routed, at least in part, through at least one other filter element or through all of the types of filter elements, for example additionally through the exchange resin. The proportion of the water that is routed to the second outlet through the other filter element or through all of the types of filter elements may be adjustable. Upstream of the second outlet, this proportion is typically mixed with the other water again. The water filter is typically configured so that it can provide both water for carbonation plants and water for heating plants. The water hardness of the water for heating plants is typically reduced by the filter in this case, at least to the extent necessary.

In variant embodiments, the inlet and the outlets are sealed in the delivered state, meaning that hygiene is maintained even with comparatively long storage. The seal used to seal the inlet and the outlets is typically configured such that it is automatically perforated when the water filter is inserted into a filter head.

As shown in FIG. 1, the feed, the cover and the container in typical water filters are arranged so as to be concentric with a central axis. This permits a compact design.

The container typically comprises a container outlet that is connected to at least the first outlet or the second outlet, irrespective of a position of the passage element.

The container 80 in FIG. 1 has a container outlet 27 that is arranged on an upper side of the container. The container outlet 27 is provided in such a way as to direct water from the container into the space upstream of the outlet 3, irrespective of the position of the passage element 22. This is part of the second path. In this way, all of the filter elements, or all of the types of filter elements, are traversed on the second path.

In typical water filters, the passage element and the feed have an intermediate space provided between them, the passage element and the container having a plurality of seals provided between them. In particular, in embodiments, the seals are arranged in such a way that, depending on the adjustment of the passage element, it is possible for water to be discharged into the intermediate space from a container opening and through a passage opening.

In typical embodiments as in FIG. 1, the intermediate space between the passage element 22 and the feed 21 is sealed with respect to the feed 21 by a feed seal. This prevents water from transferring directly from the feed 21 into the intermediate space.

In typical embodiments, the passage openings, the container openings and the seals are arranged in such a way that water from the container, having traversed only one filter element, for example, or not all of the filter elements, is directed out of the container again into a region of the intermediate space that is delimited by seals. At least one of these regions may be connected to at least one of the outlets, with the result that a bypass that avoids at least one of the filter elements of the water filter can be produced in this way. Adjusting the passage element relative to the container by means of the adjusting device or the adjusting wheel allows at least a proportion of the water to be directed via this bypass.

Typical water filters comprise a connecting edge arranged on the container, in particular arranged on an upper edge of the container. The connecting edge can have recesses or projections for attaching the container to a filter head. In these ways, weight forces and at least some of the reaction forces of the water pressure are introduced directly into the filter head. The form-fit connection between the cover and the container is not stressed by the weight force.

Embodiments of the invention also comprise filter systems having a water filter in one of the embodiments described herein and a filter head 50 to which the water filter is releasably attachable. By way of example, the releasable attachment may be configured in such a way that it is releasable using a rotational movement or using a tilting movement, in particular without a tool.

A typical example of a filter holder 50 and/or filter head that is suitable for the water filter 100 in FIG. 1 is shown in FIG. 1. The filter holder lengthens the inlet 1 and the outlets 2 and 3 of the water filter through its housing. The filter holder 50 is placed onto and attached to the top of the water filter, or the container is attached to the filter holder 50. This results in end pieces of pipes, for example of the cover, engaging with corresponding receptacles (not shown) of the filter holder 50 in a manner known per se when the water filter 100 is inserted into the filter holder.

The filter holder 50 is attached to the connecting edge of the water filter 100 and thus directly absorbs the weight force and some reaction forces due to the water pressure. Attachment is produced by means of the connecting edge using a type of bayonet connection, which is also releasable by a user.

The releasable connection affords the advantage that a user can release the water filter and hand it to a service center, where the cover is removed and the filter elements can be replaced. This guarantees reliable maintenance of the water filter.

Typical methods for operating the typical water filter 100 comprise adjusting a position of the passage element 22 having the passage openings 23 relative to the container 80 having the container openings 25 in order to accommodate the water filter to water that can be expected at the installation site. The adjustment sets the flow cross sections the combined openings of passage openings and container openings so that an adequate proportion of the water is directed through the exchange resin, for example.

As shown in FIG. 1, the container 80 comprises an emitter 41. The emitter may be provided on a side of the container 80 that faces the filter holder 50. The emitter 41 is configured to interact with a position sensor 40 provided in the filter holder 50. The position sensor 40 is configured to output a position signal. The position signal is indicative of a position of the passage element 22.

In the embodiment shown in FIG. 1, the emitter is coupled, for example connected with a force or form fit, to the passage element 22. Operating the adjusting device, for example rotating the adjusting wheel 12, leads to a change in the position of the passage element 22 and the emitter 41. By way of example, the emitter 41 can be rotated in the same way as the passage element 22 by rotating the adjusting wheel 12. A position signal that is output by the position sensor 40 may be indicative of the rotational position of the emitter 41 and the passage element. In particular, the position signal may be indicative of what quantity of water is flowing through a respective filter element of a multiplicity of filter elements.

The water filter 100 shown in FIG. 1, in particular the container 80, comprises at least two filter elements having different filter functions. The first filter element may correspond to a first of the paths described herein, and the second filter element may correspond to a second of the paths described herein. The configuration shown is illustrative and may be arbitrarily modifiable. By way of example, the first filter element can comprise the carboblock 8, and the second filter element can comprise the exchange resin 9. By way of example, the first filter element comprises the particle filter 7 and the carboblock 8. By way of example, the second filter element comprises the particle filter 7, the carboblock 8 and the exchange resin 9. The passage element is configured to take the position of the adjusting device as a basis for setting the ratio between a first flow rate through the first filter element and a second flow rate through the second filter element. By way of example, the adjusting device may be configured to allow water to flow exclusively through the first filter element, to allow water to flow exclusively through the second filter element, or to allow water to flow through the first filter element and the second filter element proportionally in an arbitrarily adjustable ratio, i.e. with an arbitrarily adjustable blend level.

In embodiments, the emitter 41 and/or the position sensor 40 are configured to contactlessly determine the position signal. Contactlessly can be understood to mean that the emitter 41 may be at a distance from the position sensor 40. FIG. 1 shows the water filter in a normal operating configuration. The container 80 is attached to the filter holder 50. The emitter 41 is separated from the position sensor 40 by walls of the container 50 and/or of the filter holder 50 and is at a distance from said position sensor. Conveying the position signal contactlessly advantageously allows bushings and/or contacts, for example electrical contacts, to be omitted.

In embodiments, the emitter 41 can comprise one or more permanent magnets. The sensor 40 can comprise a magnetic field sensor. By way of example, operating the adjusting device can result in one or more parameters, for example an alignment of a magnetic field, changing, meaning that the position of the passage element is detectable on the basis of the magnetic field parameters.

In embodiments, the emitter 41 and/or the sensor 40 may be configured for optical detection of the position, for example as a light barrier. In embodiments, the emitter 41 and/or the sensor 40 can comprise an incremental emitter. In embodiments, the emitter 41 and/or the sensor 40 can comprise an inductive emitter and/or sensor. In embodiments, the emitter 41 and/or the sensor 40 can comprise a capacitive emitter and/or sensor. In embodiments, the emitter 41 can comprise a transponder, for example an RFID transponder, and/or the sensor 40 can comprise a receiver for the transponder. Any combinations of the cited detection and conveyance methods are possible.

In embodiments, the water filter 100, in particular the filter holder 50, can comprise an evaluation device (not shown). The evaluation device may be configured to receive the position signal and/or may be communicatively connected to the position sensor 40. The evaluation device may be configured for data processing. The evaluation device can contain a processor, for example a microcontroller, a memory and a software containing instructions that is stored in the memory, the software, when executed on a processor, causing the evaluation device to carry out the functions and/or methods described herein.

The evaluation device may be configured to take the position signal as a basis for determining a depletion state of the at least one filter element. By way of example, a depletion state value can be determined, on the basis of the position signal, for each filter element independently of one another. By way of example, a depletion state of the water filter 100, or of the container 80, can be determined, displayed and/or output on the basis of one or more filter elements, for example the filter element having the highest depletion state value.

In embodiments, the depletion state can be determined on the basis of time. By way of example, a typical, general water consumption in a household over a specific period may be assumed and/or set. By way of example, it can be assumed that the filter element having the exchange resin 9 is exhausted after a first period of use and the filter element having the carboblock 8 is exhausted after a second period of use, which is independent of the first. By way of example, it can be assumed that, given typical consumption, exhaustion occurs for the respective filter element after an effective period in which there is a blend level of 100%, i.e. an effective flow of water exclusively along the path that contains the filter element. The position signal can be taken as a basis for accommodating, in particular extending, the period, for example indirectly proportionally. By way of example, the period can be extended, for example doubled, for a blend level of e.g. 50%.

In one advantageous development, the water filter 100 can comprise a quantity sensor for gauging a quantity of water filtered by the water filter. By way of example, the quantity of water may correspond to the quantity of water flowing in through the inlet 1. The quantity sensor may be a flow sensor and/or a flow rate sensor. The quantity sensor can comprise a known flow rate sensor, for example an ultrasonic flow rate sensor, a magnetoinductive flow rate sensor, a vortex flow rate sensor, a pressure sensor, in particular a differential pressure sensor, or other known sensor types. The quantity sensor may be communicatively connected to the evaluation device. The quantity sensor may be configured to ascertain the quantity of water directly. Equally, the quantity sensor can ascertain the abstracted quantity of water indirectly, for example by assuming a typical flow rate for the water filter 1 and gauging a flow that has not been ascertained more precisely, for example using a pressure drop in the region of the inlet 1. In the development, the evaluation device is configured to also determine the depletion state on the basis of the quantity of water. By way of example, instead of or in addition to the first and/or second period of use, a usable volume and/or a usable quantity of water may be defined for the respective filter elements. Exhaustion of the respective filter element can occur as soon as the usable volume for the respective filter element has been exceeded.

In embodiments, the container 80 contains a transponder 30 permanently connected to the container 80, in particular a transponder that is not nondestructively separable. By way of example, the transponder may be an RFID tag, in particular a transponder configured for near field communication. The water filter 100, in particular the filter holder 50, can comprise a reader (not shown) configured for communication with the transponder 30. Both the reader and the transponder 30 may be transceivers, i.e. in particular be configured both for sending and receiving and/or for reading and writing data.

The transponder 30 may be configured to store values in a memory provided in the transponder and to generate a transponder signal comprising the values that is able to be used to transmit the values to the reader communicatively, in particular wirelessly. The transponder signal can be generated as a result of a communicative connection between the reader and the transponder 30. In particular, the reader may be configured to query the values and/or to receive the values from the transponder as a result of a request by the reader. The reader may be communicatively connected to the evaluation device and/or may be integrated in the evaluation device, with the result that the values are receivable, evaluable and/or usable by the evaluation device.

The values can comprise a container identifier. The container identifier may be for example a unique serial number of the container. Alternatively, or additionally, the container identifier can comprise other values, for example a production date, a batch number, a best before date or the like.

The values can comprise a container type identifier. The container type identifier may be for example a unique identification number and/or identifier of the container. The container type identifier may be suitable for making the container 80 identifiable as a compatible or incompatible container type for the filter holder 50, for example.

The values can comprise container property values. The container property values can include for example information about which filter elements are present in the container 50. Additionally, the container property values may comprise information about the period of use that can be expected and/or a usable volume of the respective filter elements that can be expected. On the basis of the container property values, it may be possible for the evaluation device to determine the depletion of the respective filter elements in relation to the period of use that can be expected, for example in order to determine that the filter elements are exhausted.

The values can comprise container depletion state values. By way of example, the container depletion state values can include information about whether and to what extent one or more filter elements present in the container 80 are depleted and/or (partially) exhausted.

Values, in particular container property values and/or container depletion state values, can change while the water filter 100 is being used. The reader may be configured to write values to the memory of the transponder. By way of example, updated container depletion state values can be written to the transponder in order to store the actual state of the depletion of the filter elements. By way of example, container property values that are indicative of the container 80 having transitioned from an e.g. sealed, unused new state to a used state can be written to the memory. By way of example, container property values and/or container depletion state values that are indicative of the container 80, in particular one or more filter elements, being partially or completely depleted and/or exhausted can be written to the memory. Even if the container is changed, for example from a first filter holder 50 to a second filter holder 50, the container property values can thus advantageously be read and evaluated by the second filter holder 50.

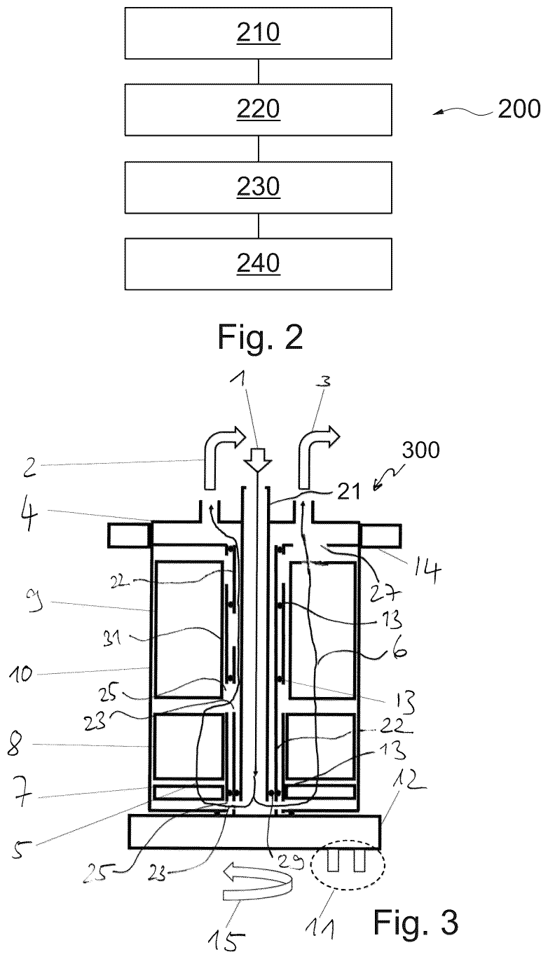

FIG. 2 describes a method 200 for operating a water filter according to embodiments described herein. The method comprises adjusting 210 a position of the passage element having the passage opening relative to the container having the container opening in order to accommodate the water filter. The adjustment can be made for example by rotating the adjusting wheel 12.

The method comprises determining 220 the position of the passage element 22 using the position sensor, in particular a position of the passage element 22 in relation to one or more container opening(s) 25 and/or other fixed parts of the container 80.

The determined position, for example in the form of a position signal, can be conveyed to an evaluation device of the water filter 100 and preferably evaluated by said evaluation device.

The method can comprise measuring 230 a quantity of water filtered by the water filter. By way of example, the quantity of water can be determined by a quantity sensor and/or can be determined on the basis of a quantity sensor signal. In particular, the method can comprise measuring the filtered quantity of water, and determining the quantities of water filtered by different filter elements, for example by virtue of the total water filter quantity being k proportionally assigned to a respective filter element on the basis of the position signal. The determination can be carried out by the evaluation device.

The method can comprise, for example on the basis of the determined filtered quantity of water and/or the position of the passage element, determining 240 a depletion state of the water filter. The determined depletion state may correspond to a depletion and/or an exhaustion of the filter elements provided in the container. In particular, the depletion state may be indicative of one or more of the filter elements being (partially or completely) depleted and/or exhausted, or not exhausted.

A typical method 200 comprises inserting a container 80 into the filter holder 50, for example on the part of a user and/or end consumer. If the container 80 has a transponder provided in it, the filter holder 50 can query values from the container 80 and for example determine the type and/or the depletion state of the container and/or of the filter elements provided therein.

Before or even after the container 80 is inserted, the user can operate the adjusting device in order to adjust the water filter. By way of example, the consumer can accommodate the container to the local water hardness, or other individual properties of the available water.

In some embodiments, the water filter 100 can advantageously be used such that, depending on the intended use of the abstracted water, either completely decalcified and/or demineralized water or blended water is abstracted.

Before and/or during operation, an evaluation device provided in the filter holder can determine the position of the passage element using the position sensor, or can receive a position signal from the position sensor. Using the position signal and optionally also on the basis of a water quantity signal and/or values received from the transponder, the evaluation device can determine a depletion state of the water filter, for example at predefined intervals or whenever the water filter is used. If necessary, values, for example container depletion state values and/or container property values, can be written back to the transponder.

In embodiments, the method can comprise forecasting the time at which the container 80 can be expected to be exhausted, for example by extrapolating recorded depletion state values on the basis of time. A user can thus be warned and/or asked to replace the container 80 in good time before exhaustion.

The filter holder 50 can comprise a display means, for example a display, a light-emitting diode, an audible signal transmitter, or even a means a communicative connection to a communication device, for instance a smartphone of the user. The display means can be used to output an instantaneous depletion state of the container 80, for example, and/or to output a warning, as soon as one or more of the filter elements are depleted.

To provide a better understanding of the invention, FIG. 3 shows a container 300 for a water filter that differs from the container 80 according to the invention by virtue of the absence of an emitter 41 and/or a transponder 30. A cover 4 provided opposite the adjusting wheel 12 closes the container 300. The adjusting wheel is rotatable about an axis, as shown by arrow 15. A connecting edge 14 is provided for attaching the container 300 to a filter holder 80. The container 300 comprises an external wall 10. The container 300 has the container openings 25, which, together with the passage openings 23 and the seals 13, define the path 5 and the path 6. In the path 6, the water flows through all of the filter elements 7, 8, 9, whereas the water does not flow through the exchange resin 9 in the path 5. The feed seal 29 seals the intermediate space between the passage element 22 and the feed element 21 with respect to the feed 21. The container 300 has, centrally along a central axis, an opening that is bounded by an internal wall 31. To display the filter quality, there is provision for a display 11. In embodiments, features of the container 300 can be combined arbitrarily with the container according to the invention.

The invention is not limited to the embodiments described hereinabove, but rather the scope of the invention is determined by the appended claims.

1. Water filter for filtering water, comprising:
a filter holder comprising a position sensor; and
a container that is couplable to the filter holder, comprising:
a passage element being movable relative to a container opening of the container and having a passage opening;
a feed for feeding water to the passage element; and
an adjusting device for adjustably positioning the passage element having the passage opening relative to the container having the container opening; and
an emitter, the emitter being configured to interact with the position sensor, so that the position sensor is configured to output a position signal indicative of a position of the passage element having the passage opening.

2. Water filter according to claim 1, wherein the container comprises at least one filter element.

3. Water filter according to claim 1, wherein the container comprises:
a first filter element having a first filter function;
a second filter element having a second filter function different than the first filter function; wherein
the passage element is configured for setting the ratio between a first flow rate through the first filter element and a second flow rate through the second filter element depending on the position of the adjusting device.

4. Water filter according to claim 1, wherein the emitter and the position sensor are configured to contactlessly determine the position signal.

5. Water filter according to claim 1, wherein the emitter comprises a permanent magnet, and wherein the position sensor comprises a magnetic field sensor.

6. Water filter according to claim 2, comprising an evaluation device that is configured for determining a depletion state of the at least one filter element based on the position signal.

7. Water filter according to claim 6, comprising a quantity sensor connected to the evaluation device for determining a quantity of water filtered by the water filter, the evaluation device being configured to further determine the depletion state on the basis of the quantity of water.

8. Water filter according to claim 1, further comprising:
a transponder permanently connected to the container;
a reader for receiving a transponder signal transmitted by the transponder.

9. Water filter according to claim 8, wherein
the transponder signal comprises one or more selected from the group consisting of the following:
a container identifier;
a container type identifier;
one or more container property values; and
one or more container depletion state values.

10. Water filter according to claim 8, wherein the reader is configured to write values to a memory of the transponder.

11. Water filter according to claim 10, wherein the values comprise one or more selected from the group consisting of:
container property values, and
container depletion state values.

12. Water filter according to claim 1, wherein the adjusting device is configured to adjustably position the passage element relative to the container opening by a rotation about an axis.

13. The water filter according to claim 1 being configured for filtering water in a household at a maximum flow rate of 20 liters/min.

14. Method of operating a water filter, the water filter comprising:
a filter holder comprising a position sensor; and
a container that is couplable to the filter holder, comprising:
a passage element being movable relative to a container opening of the container and having a passage opening;
a feed for feeding water to the passage element; and
an adjusting device for adjustably positioning the passage element having the passage opening relative to the container having the container opening; and
an emitter, the emitter being configured to interact with the position sensor, so that the position sensor is configured to output a position signal indicative of a position of the passage element having the passage opening, the method comprising:
adjusting a position of the passage element having the passage opening relative to the container having the container opening in order to adjust the water filter;
determining the position of the passage element using the position sensor.

15. Method according to claim 14, comprising:
determining a quantity of water filtered by the water filter;
determining a depletion state of the water filter based on the filtered quantity of water and the position of the passage element.
